(19) United States
(12) Patent Application Publication
(10) Pub. No.: US 2003/0084791 A1
(43) Pub. Date: May 8, 2003

(54) Method and system for optimizing ingredient blending

(76) Inventors: Sara J. Trenhaile, Maple Grove, MN (US); Amy J. Burke, Bloomington, MN (US); Alvin Ghylin, Maple Grove, MN (US); Marilee Giron, Rogers, MN (US); Lisa L. Curran, West Des Moines, IA (US)

Correspondence Address: GENERAL MILLS, INC., P.O. BOX 1113, MINNEAPOLIS, MN, 55440, US

(21) Appl. No.: 10/008,276

(22) Filed: Nov. 8, 2001

(51) Int. Cl. B01F 15/02

(52) U.S. Cl. 99/486; 366/150.1

(57) ABSTRACT

An automated grain blending processing system enables one to track and optimize the actual cost associated with mixing or blending grain to provide consistent blends having good milling quality, cost efficient blending so customers receive the best quality product, and tracking of performance for particular grades or mixtures of product so as to, for example, eliminate blending and costing errors. Commodity-based costing data can be downloaded over a network and used to calculate an actual cost of blending a product. The difference (positive or negative) between actual blend cost and a model blend cost can be calculated, and blending decisions can be made based at least in part on the calculation. A blend processor can generate a blend mix output that specifies the amount of each of plural grain lots to mix in order to achieve said desired mix. A mass storage device operatively coupled to the blend processor may store historical data concerning previous blends. As each mix is completed, historical data indicating the actual cost and performance characteristics associated with the manufacture of each lot of such products can be stored. Non-limiting advantages include tracking actual mix costs versus standard blend costs, integration with conventional inventory control system and grain cost card, documenting performance by blend (e.g., flour) grade, and allowing for an accurate comparison of blending over time.

### CROSS-REFERENCES TO RELATED APPLICATIONS

None.

### STATEMENT REGARDING FEDERALLY SPONSORED RESEARCH OR DEVELOPMENT

Not Applicable.

### FIELD OF THE INVENTION

The present invention relates to a method and system that optimize ingredient selection for use in manufacturing products. More specifically, the present invention relates to using automatic data processing techniques to optimize the blending or mixing of grains or other components of food products. Even more particularly, the invention relates to determining and automatically processing the cost and/or other characteristics of grains or other components so that functional, nutritional and/or other targets of the various blends or mixes for particular food products can be met, while simultaneously meeting fiscally responsible requirements to manufacture products to provide good consumer value at acceptable manufacturing profitability levels.

### BACKGROUND AND SUMMARY OF THE INVENTION

Food products and food product intermediates (e.g., flour or dough) are typically made by blending or mixing ingredients or components that have been selected for their properties to achieve an end product that has a particular consistent desired characteristics (e.g., protein functionality, taste, texture, moisture content, nutritional benefit, etc.). Careful and consistent ingredient blending or mixing in accordance with a particular specification, recipe or ingredient list ensures that the consumer of mass marketed or branded products will receive the same quality each and every time he or she purchases the product and can also ensure the product will comply with any health and nutritional claims set forth on the label.

Grain blending is commonly used in the manufacture of flours, cereals, and other grain-based products to achieve uniform quality. For example, different lots of the same type of grain can vary significantly in terms of moisture content, protein content and other variables. By blending together different lots of the same (or in some cases and in some countries, different) grain type(s), it is possible to obtain nearly exactly the overall grain characteristics that are desired. Blending can also be used to provide consistent grain characteristics over time even though different available grain lots may have non-uniform characteristics due to growing conditions, storage conditions and other variables.

For example, blending together moister and dryer and/or higher and lower protein content lots of the same type of wheat can allow one to obtain a wheat mixture with the precise moisture, protein and other characteristics desired for a particular manufacturing process (e.g., milling) or end product. To achieve this objective, the operator in the elevator often will use previously established blending specifications to draw grain types when collecting the raw material portion of an order for the mill. During a manufacturing or production run, certain grains selected in this manner for the properties (e.g., moisture, protein and/or fiber content) they possess can be transported to the mill where they are mixed and then ground or further processed into the end product (e.g., flour).

Blending differently priced grains can also be used to achieve an overall desired quality level while realizing significant cost savings. Grain prices may fluctuate due to circumstances beyond the control of the manufacturer, such as due to weather conditions, available supplies, political instability in grain growing regions, loss or accidents during transportation, infestation, disease and other factors. Anyone who has ever tried to follow the commodities market knows that the prices of wheat, corn, oats, barley and other grains can be very volatile and subject to large and unexpected fluctuations. Such price fluctuations create potentially significant problems—but also potentially significant opportunities—to manufacturers that purchase grains for making their food products.

Because of fluctuations in the commodities market, the cost of making a particular product or formula may suddenly and unexpectedly exceed a standard cost model or ideal cost—that is, the cost at which the manufacturer can produce the product and still realize an acceptable profit. In situations where the cost of the grain escalates, the manufacturer may end up producing the product at a loss and ultimately be forced to either lose profitability or pass price increases along to the consumer. Typically, the manufacturer will not immediately recognize the loss suffered in product that has just been prepared. Therefore, the loss may increase in a cumulative fashion as additional lots are manufactured until the manufacturer realizes what has transpired. This can present serious profitability problems and associated business planning destabilization.

In situations where certain premium grains are available in abundance at lower cost in the marketplace, not knowing the current price or availability of the grains deprives the manufacturer of the opportunity to manufacture a higher quality product (e.g., one having higher protein or fiber content) to the consumer at the same or even a reduced price. Moreover, such situations of lower prevailing cost—if the manufacturer could recognize and act on them in time—would enable the manufacturer to pass along the cost savings to the consumers through promotions and/or overall price reduction and/or allow the manufacturer to increase profitability to hedge against subsequent grain price increases.

Of course, current grain prices are relatively easy to determine from newspaper and commodities trading and reporting services accessible over the Internet or otherwise. Even where grain purchase and blending decisions have been made based on prevailing commodities pricing, it has generally not been particularly practical for a blender of grain or other raw materials at the operator level to systematically optimize grain blending so as to take such effects into account in real time.

Naturally, computers and other automatic data processing systems have been used in the past to help manage grain inventory. For example, in the past, inventory management systems have been used to track the inventory of grain supplies and the cost associated with the purchase of such crops. However, such systems generally may sometimes actually exacerbate the problems discussed above. For example, inventory management systems generally may track the total amount of grain being delivered in a particular shipment and the acquisition cost (purchase price) of the grain but may fail to project the cost of actually manufacturing products from the delivered grain—making it difficult if not impossible to pinpoint problems or opportunities in the manufacturing area.

Many such conventional inventory control systems tend to maintain grain information in a static as opposed to variable manner. As additional varieties are developed or growing conditions change, the characteristics of the grains may change. Likewise, moisture content of a lot of grain may change over time due to storage conditions and/or the amount of time the grain is stored, commodity prices may also fluctuate on a more frequent basis as opposed to manufacturing or ordering cycles. Sometimes, the price of grain changes on a moments notice as announcements are made about long term weather forecasts or other situations occur, such as a train derailment or infestation, which can effect the quality and availability of the grain. Where grain is held on a consignment basis, sudden price spikes in the cost of the grain may not be immediately known to the manufacturer which can severely impact the actual cost of processing or mixing the grain. Where grain supplies have already been purchased, immediate knowledge of price changes would enable premium grains to be used more effectively or economically in order to avoid cost overruns and realize cost savings when possible.

What is needed is a system and method in which grains or other ingredients or components can be selected in a certain manner based on existing or current inventory that will provide for product consistency while at the same time enabling the manufacturer or miller to produce the product at an acceptable cost level.

The present invention provides such a system that enables one to track and optimize the actual cost associated with mixing grain.

In accordance with one aspect of an illustrative embodiment of the invention, an automated blend processing system provides consistent blends having good milling quality, provides cost efficient blending so customers receive the best quality product, and provides for tracking of performance for particular grades or mixtures of product so as to, for example, eliminate blending and costing errors.

In accordance with one aspect of a preferred exemplary but non-limiting embodiment, a method for optimizing ingredient selection for further processing comprises the steps of providing a supply of at least one ingredient; calculating at least a first element of the at least one ingredient contained with the supply; and selecting the at least one ingredient from the supply based on the calculation which correspond to a predetermined recipe to achieve an end product.

Another aspect of a preferred illustrative but non-limiting embodiment provides a method for producing a blended product comprising downloading, over a network, time-sensitive data representing the current cost of at least one material whose price fluctuates based at least in part on market conditions; using the downloaded current cost information to calculate an actual cost of blending the product; automatically calculating the difference between the actual blend cost and a model blend cost; and making a decision to blend the product based at least in part on the calculation.

A still further aspect of an illustrative but non-limiting embodiment provides a system for controlling grain mixing, the system being coupled over a data network to a source of current grain prices, so that the system receives information relating to grain cost currently on hand. The system includes a blend processor, which based on desired mix and source bin designations, calculates a blend cost and compares the blend cost with a retrieved model cost. The blend processor generates a blend mix output that specifies the amount of each of plural grain lots to mix in order to achieve the desired mix. A mass storage device is provided and is operatively coupled to the blend processor. The mass storage device stores historical data concerning previous blends. As each mix is completed, historical data indicating the actual cost and performance characteristics associated with the manufacture of each lot of such products can be stored.

Non-limiting advantages provided by illustrative embodiments of the invention include for example:

tracking actual mix costs versus standard blend costs,

integration with conventional inventory control system and grain cost card;

document performance by blend (e.g., flour) grade,

allowing for an accurate comparison of blending over time.

### BRIEF DESCRIPTION OF THE DRAWINGS

These and other features and advantages provided in accordance with presently preferred exemplary embodiments of the invention will be better and more completely understood by referring to the following detailed description in connection with the drawings, of which:

FIG. 1 is an illustrative schematic diagram of a blend processing system 100;

FIG. 2 shows a more detailed schematic illustration of exemplary blend processing system 100;

FIG. 3 shows an example blend processing flowchart;

FIG. 4 shows example data structures and interactions therebetween;

FIG. 5 shows an example blend menu screen;

FIGS. 6 and 7 show example blend entry data forms;

FIGS. 8 and 8A show example illustrative blend mix sheets; and

FIGS. 9, 9A and 10 show example blend history displays.

### DETAILED DESCRIPTION OF PRESENTLY PREFERRED EXEMPLARY EMBODIMENTS

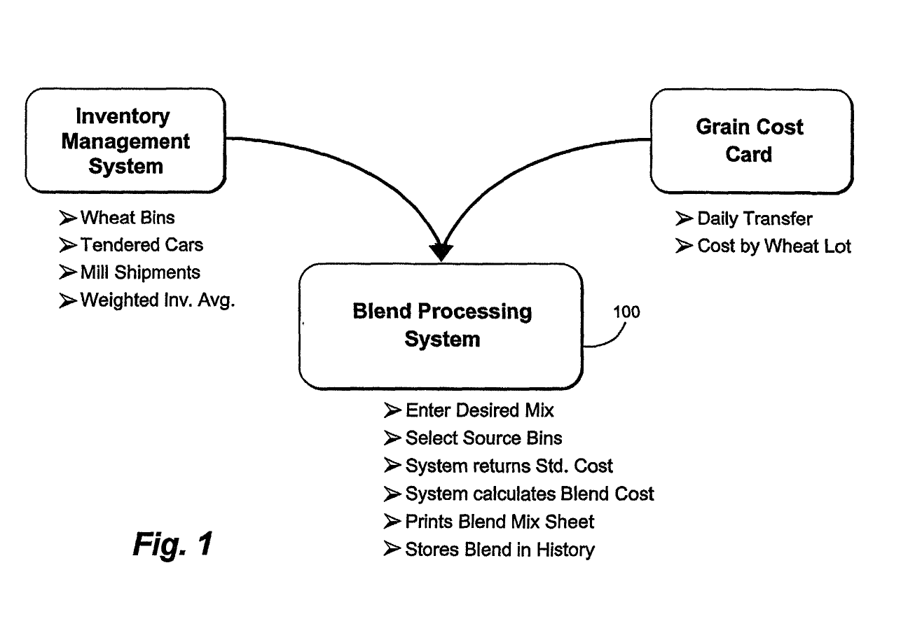

FIG. 1 schematically illustrates an overall automated blending system and method provided by a presently preferred example embodiment of the present invention. The illustrative, non-limiting system and method shown in FIG. 1 includes a blend processing system 100 that receives certain inputs in the form of data and performs certain automatic data processing and calculations so as to generate outputs used by a manufacturer to blend component ingredients (e.g., different lots of grain used to mill flour).

As shown in FIG. 1, blend processing system 100 receives certain data describing available component inventory and milling requirements. In the case of grain blending, such input data can include, for example:

wheat bins on hand (including, for example, grade and type of wheat in each bin, moisture content, protein content, fiber content, weight, and other pertinent information);

identification of tendered cars containing wheat to be blended (e.g., once again, this data may include information concerning wheat characteristics and amounts as discussed above);

scheduled mill shipments (including particular mixture characteristics required by the mill); and

weighted inventory average.

As also shown in FIG. 1, exemplary blend processing system 100 may have access to a grain cost card providing information concerning the daily transfer costs by wheat lot. In the preferred exemplary embodiment, such grain cost card information is updated daily based on current commodity price fluctuations so that the blend processing system 100 always has pertinent current cost information.

In the exemplary embodiment, blend processing system 100 requests an operator to input desired mix specifications (these can come from the mill in some instances) and source bin selection. The blend processing system 100 automatically returns the standard cost, calculates proposed blend cost and outputs a blend mix sheet for use by the silo, bin and other operators in delivering the appropriate mix required. The preferred exemplary embodiment blend processing system 100 also stores the blend in a history file for later access.

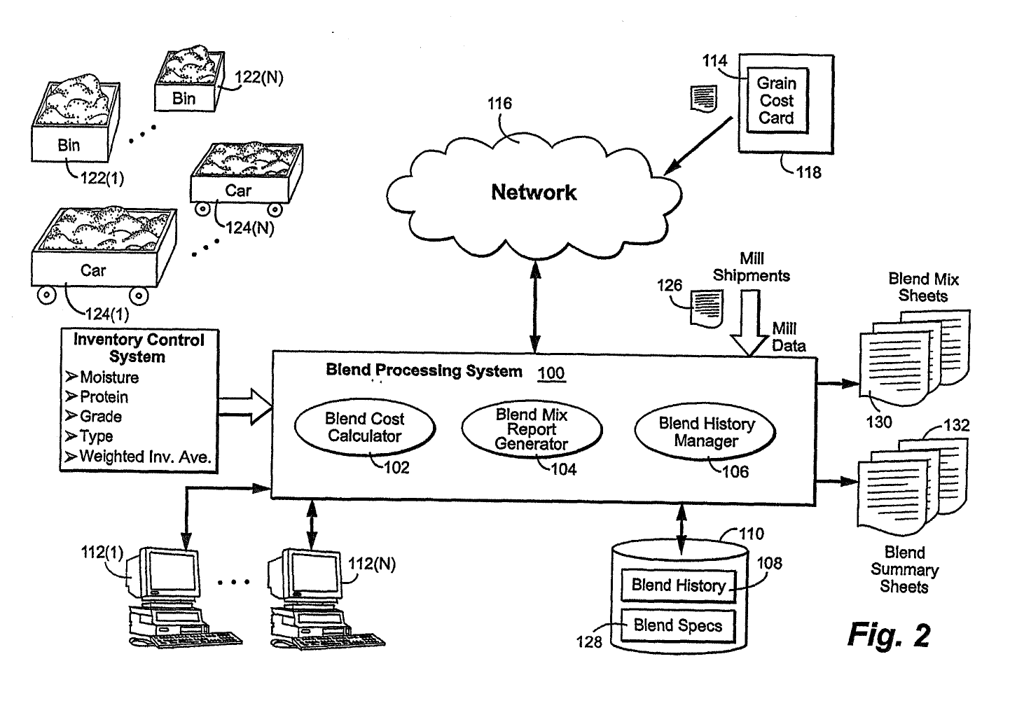

FIG. 2 shows the preferred illustrative blend processing system 100 in more detail. In one example embodiment, blend processing system 100 may be implemented as software running on a conventional personal computer, but other arrangements (e.g., client-server, mini computer, distributed processing or other architectures) may be used if desired. In the example embodiment, blend processing system 100 may also interact with user input/display devices 112 to receive user inputs and display information to users.

In the example embodiment, blend processing system 100 may access current grain cost card data 114 via a network 116 connected for example to a remote server 118 providing current commodity price information. Other input arrangements (e.g., manual data entry in response to queries or the like) are also possible.

In the example embodiment, blend processing system 100 may also interact with an inventory management and control system 120 providing a variety of data concerning grain bins 122, cars 124 or other grain storage receptacles. For example, in the case of flour manufacture, certain grains (e.g., oats, wheat, corn and barley) are generally stored in large grain elevators, bins or silos. The grain may either be held on consignment (that is, the grain is paid for when taken from the inventory but ownership remains with the grower or distributor), or purchased in advance. In a consignment situation, the grain may be transported to and located at the manufacturer's site to reduce spoilage incurred during transportation and to facilitate inventory usage. In the example embodiment, the inventory control system 120 may be, for example, conventional software running on the same or different platform that provides grain lot information for each bin, silo, car or other grain lot receptacle. Such conventional inventory control systems may provide additional useful functionality, e.g., whether there was grain infested with fungus; bacteria or vermin; how much grain was actually unloaded from the total shipment and how much was returned due to defects. Such systems may also track a stated protein content or moisture content and other information including, for example:

moisture content,

protein content,

amount,

grade,

type,

weighted inventory average,

other pertinent information.

Also as shown in FIG. 2, the blend processing system 100 may receive mill shipment data 126 from a mill or other manufacturing process requiring the raw materials for mixing. Such mill data 126 may include, for example, schedule information, mixture requirements, and other pertinent information. Blend specifications 128 may also be stored on mass storage device 110 if desired.

In this illustrative drawing, blend processing system 100 includes a blend cost calculator 102, a blend mix report generator 104 and a blend history manager 106. Blend history manager 106 may interface with blend history files 108 stored on a mass storage device 110 (e.g., a magnetic disk drive or the like) to retrieve and update blend history data. Blend processing 100 may perform its processing based on the mill data 126, the grain cost card information 114, information provided by the inventory control system 120, and additional information inputted via user input/output devices 112. As mentioned above, the preferred exemplary output of blend processing 100 may comprise blend mix sheets and blend summary sheets 130. These outputs may be printed on a conventional printer, displayed on a conventional display, and/or transferred (e.g., over network 116 or otherwise) directly to a mill or other manufacturing process in order to control the manufacturing process (e.g., to specify which grain lots are to be mixed with which other grain lots at which time to provide a desired grain mix for milling).

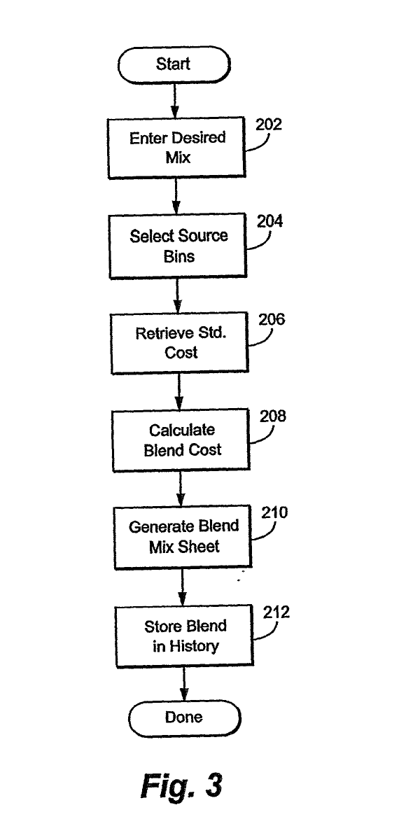

FIG. 3 shows an example process that may be performed by illustrative blend processing system 100. In an illustrative and non-limiting preferred embodiment process shown in FIG. 3, the mill enters the mix or recipe that is required for the days production or manufacturing run (block 204). Once the mix is entered, the system selects the bins or silos that are to provide the grains used in making the specific mix. Once the bins are selected, a standard cost card or template is retrieved and/or created (block 206). The cost card shows the approximate cost, grains are commonly priced in bushels, as well as other properties of the grain to be mixed, i.e. protein or fiber content, moisture and weight of the grain. Blend cost is calculated (block 208) and a blend mix sheet is produced (block 210). If costs and characteristics are determined to be in line with the model that the mill is to follow, the mix sheet is used to control which grain is removed from which bins to be forwarded to the mill for processing. In the event that the cost or other characteristics are out of sync with the desired elements of the recipe, the process is repeated and the blend of grains changed in order to meet the needs of the formula being processed. If the mix sheet is used, it is stored in the history file 108 for later retrieval (block 202).

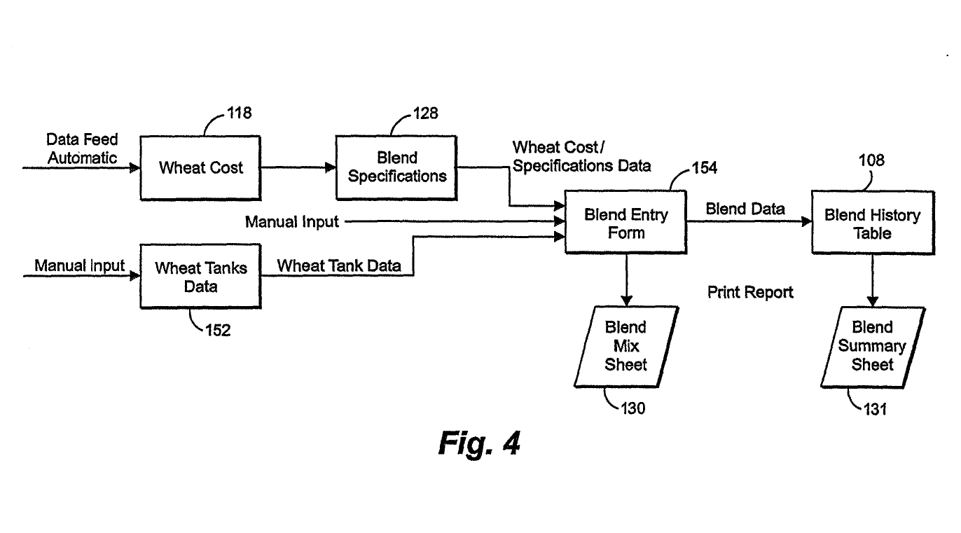

FIG. 4 shows a more detailed illustrative schematic of the processes performed by exemplary blend processing system 100. In this example, wheat cost table 118 is used to give the mill the total cost for each mix based on the daily grain costs. It lists all wheat lots, the cost of each lot and the percentages of each lot component of the standard blend. This table is updated on a daily basis. The grain cost card populates this table. For example, the table may be updated on a nightly basis through a computer software job run by an automated scheduler.

In the FIG. 4 example, the blend specifications 128 provide details for standard wheat lot composition for each mix produced at an individual mill. The blend specifications 128 may list the grain lot, the percentage and cost for each mix. In the preferred exemplary embodiment, blend processing system 100 looks at the cost card for a specific mix and gets the lot information, price and percentages directly from the wheat cost table 118 and updates the blend specification 128 cost information accordingly. In this way, illustrative system 100 always maintains current cost information that takes into account commodity price fluctuations, to thereby provide up-to-date cost planning and other advantages.

In the example embodiment, the wheat tank data structure 152 provides a grain bin inventory table for the mill along with the values for key grade factors. The wheat tank data 152 may, for example, list all grain bins, grain costs and percentages of each lot. In the example embodiment, this table inventory is updated on a daily basis by the elevator operator.

In the example embodiment, the wheat cost data 118, the blend specifications 128 and the wheat tanks data 152 are used to populate a blend entry data form 154 that is displayed to a user via user terminal 112. The blend entry data form 154 in the exemplary embodiment is used to enter new blend information, and calculate cost and savings automatically. In the example embodiment, the data entry required includes mill date, length of run or total bushel amount, flour grade, percent, wheat variety, bin number, and other information. The blend entry form 154 and associated functionality produces a blend mix sheet report 130 which displays blend percentages and compares actual cost to standard cost.

In the example embodiment, the blend data produced by the blend entry data form 154 and associated processing functionality is stored in a blend history table 108. Blend history table 108 lists all blends made along with their costs and savings versus the standard mix cost (i.e., blends, percentages, costs and savings). The blend history table 108 can be filtered by various criteria to produce a blend summary sheet report 131 which displays blend history data based on the particular selected criteria.

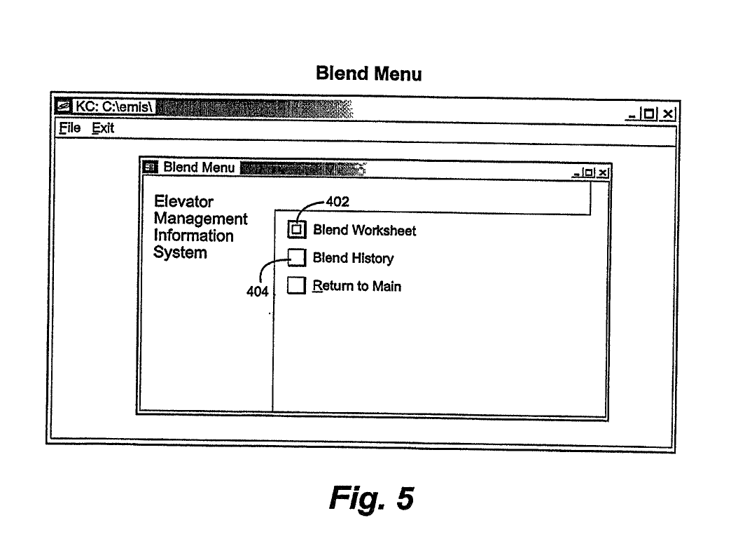

FIG. 5 shows an example initial menu selection allowing a user to select between a blend worksheet (button 402) and a blend history (button 404). In the example embodiment, selecting the blend worksheet allows you to work a new blend with the current cost card or view a blend that has not yet been archived so that consistency from mix to mix can be better managed. Selecting blend history allows you to view any archived blends and report on those.

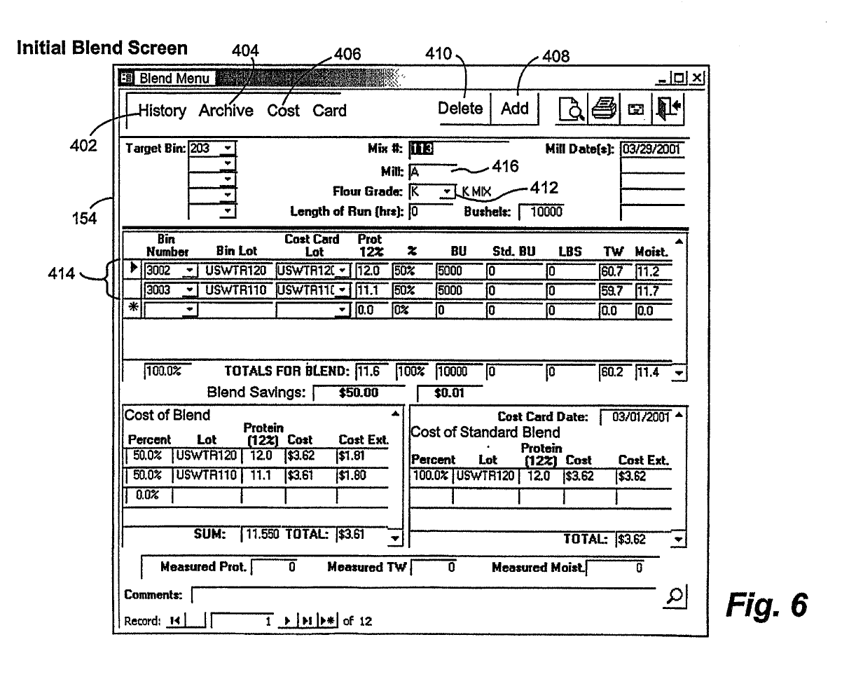

Assuming that the blend worksheet option is selected, illustrative blend processing 100 will display on user data terminal 112 in exemplary data input/output blend entry data form 154 as shown in FIG. 6.

In the embodiment illustrated in the exemplary FIG. 6 screen display format (“blast”), the particular recipe to be manufactured is for a flour, such as Gold Medal® Flour (available from General Mills, Inc. Minneapolis, Minn.). The desired characteristics of the particular flour in this example are intended to have a protein content of 12% and the target is to produce a product having a cost at $3.62 per bushel or less. The total production run is for a 10,000 bushels or $36,200.00. In manufacturing this particular product, consumers have expectations that the brand will achieve a certain performance level and in order to protect the integrity of the brand the proper set of ingredients must be selected.

The example set forth in FIG. 6 shows US Winter Wheat 120 and US Winter Wheat 110 have been selected. US Winter Wheat 120 has a protein content of 12% and in the example is shown to have a cost of $3.62 per bushel. US Winter Wheat 110 is illustrated to have a protein content of 11.1% and a cost of $3.61 per bushel. The blend calls for a selection of 5000 bushels of each type of grain, to produce a blend having a protein content of 11.55% and a cost of $36,150.00 or a savings of $50 for this particular blend.

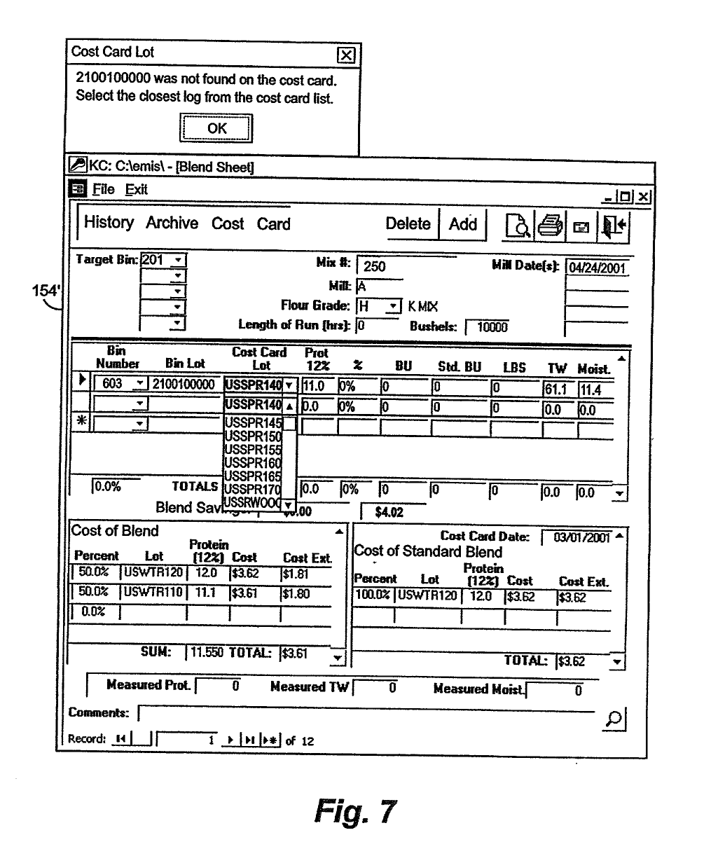

FIG. 7 shows a different blend entry data sheet 154 illustrating the use of a pull-down menu to select a particular cost card lot. FIG. 7 also illustrates how preferred blend processing system 100 automatically can indicate an instance where the user has selected a cost card lot that is not found in the current cost card, so as to automatically prompt the user to select the closest lot from the cost card list.

In the example embodiment, the illustrative blend entry data form 154 shown in FIG. 6 and FIG. 7 includes a “history” selector 402 that allows the user to see archived blends and view a history report; an archive selector 404 allowing the user to roll the current blend worksheet into the history file; and a cost card selector 406 that downloads the current cost card for use in the cost calculation. In the example embodiment, the cost card selector 406 may be displayed in red until the cost card has been downloaded every day.

In addition, the user may select the “add” selector 408 to add a new blend or the “delete” selector 410 to delete the blend worksheet that appears on the screen. In the example embodiment, the illustrative blend entry data form 154 may require the user to manually input a mill designator 416 indicating the mill that the blend is being prepared for; a flour grade selector 412 indicating the grade of flour being blended (grades correspond to the grade on the cost card in the exemplary embodiment), and a designation of bin numbers 414 indicating the bins the grain is going to be transferred from. In the exemplary embodiment, based on the bin numbers 414 inputted or otherwise selected by the user, the preferred blend processing system 100 will populate the “bin lot” field with the corresponding lot for that bin, and the “cost card lot” information will similarly be populated based on the bin lot. If the lot is not found in the cost card, the user will be prompted to select a lot closest to the lot from the cost card list (see FIG. 7, for example).

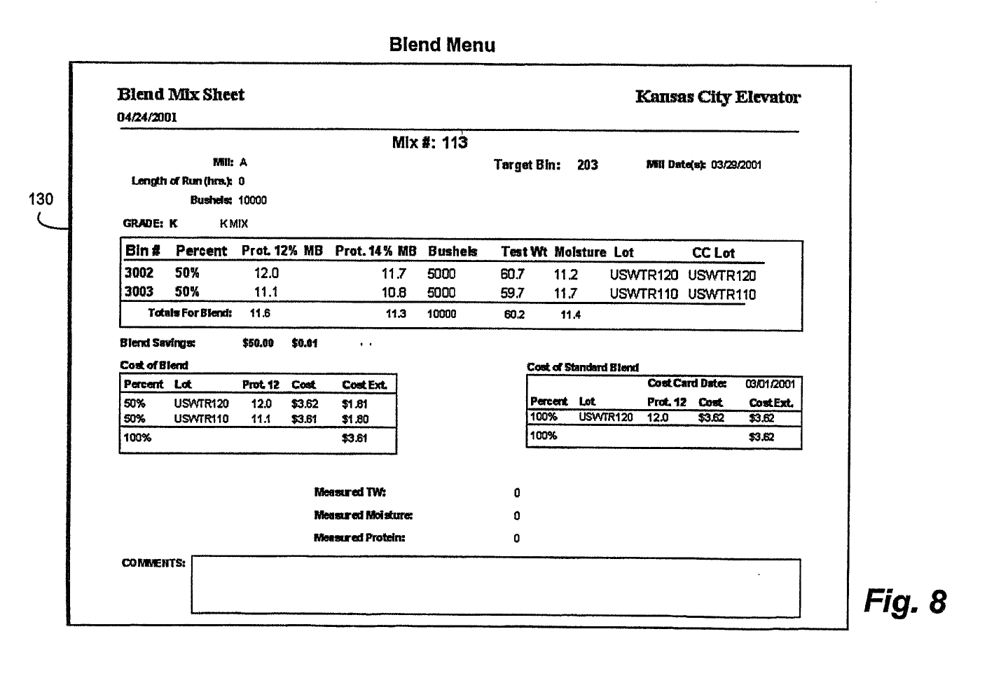

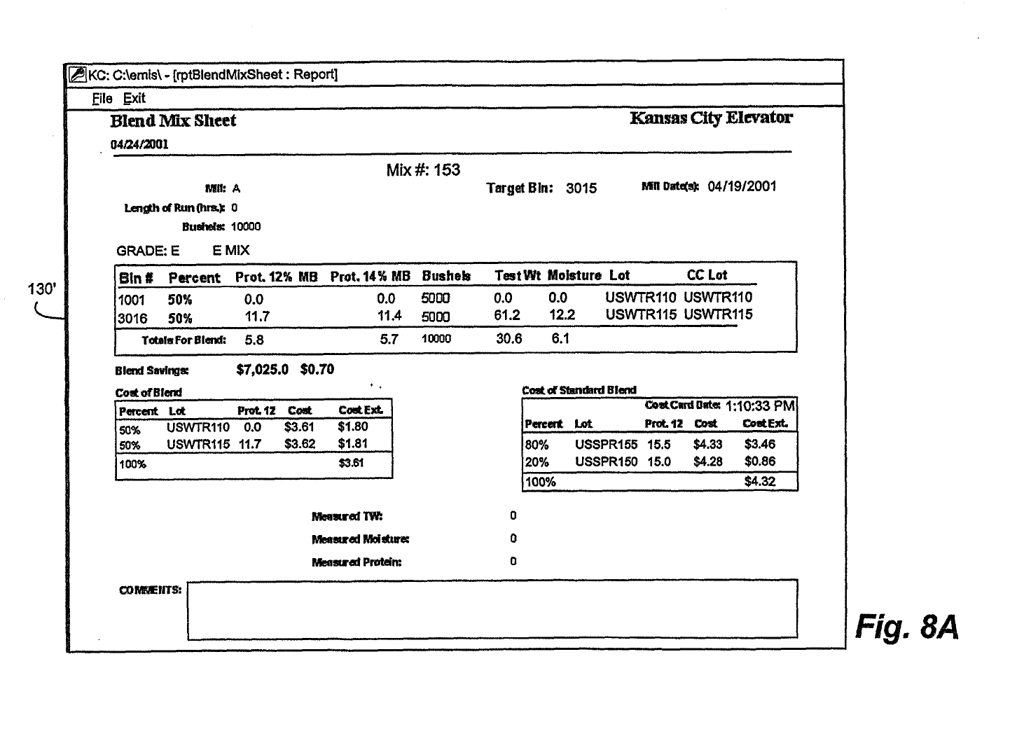

The illustrative blend mix sheet 130 shown as FIG. 8 provides the amount of the grains being used in the particular blend, the protein content of each of the grain types, the bins from which each of the grains have been selected as well as the moisture content and test weight of each of the grains. In the example shown, this particular blend mix sheet 130 tells the elevator operator to mix 5,000 bushels from grain bin number 3002 with 5,000 bushels from grain bin 3003 to provide a total of 10,000 bushels for delivery to mill A. This exemplary blend mix sheet 130 indicates that based on the current cost card data, the blend savings represent $50 off of a standard blend cost of $3.62 per bushel. This blend mix sheet information 130 is preferably used in the manufacturing process to blend the particular grains together in the amounts specified to manufacture the specific desired flour product.

FIG. 8A shows a slightly different illustrative blend mix sheet 130′ illustrating a more substantial cost savings. Note that in the example embodiment, the blend mix sheet 130 includes essentially all the information from the blend worksheet 154. The measured protein, measured TW and measured moisture are optional fields but may be a necessary component in some applications.

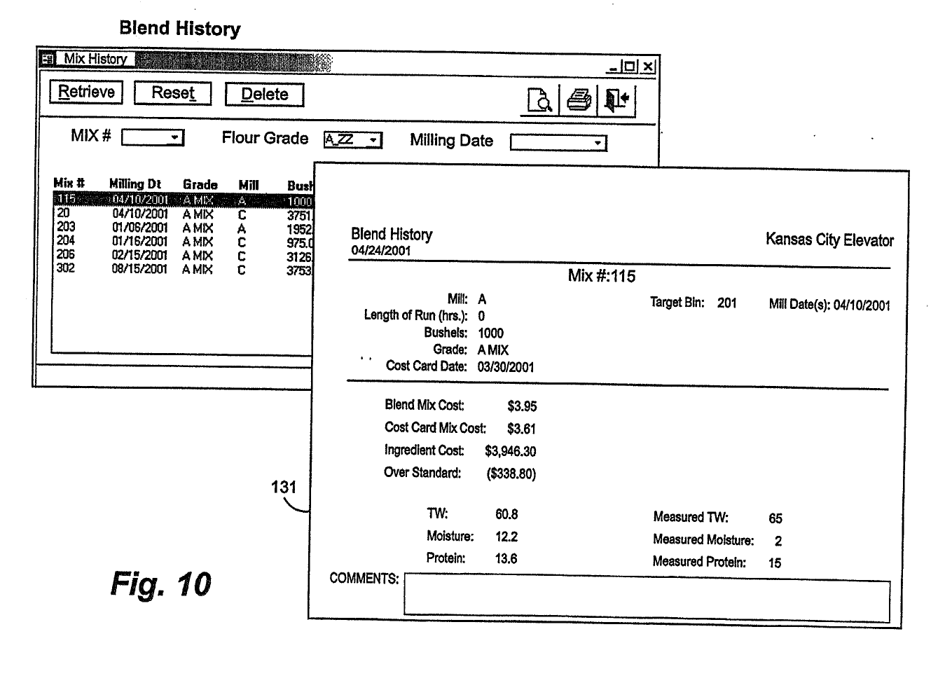

The blend history shown as FIG. 10 illustrates a blend in which the target profitability/cost threshold is exceeded. This illustrates the impact that price fluctuation can have on the processing of a particular recipe or formula. The historical blend data from Mar. 30, 2001 shows that the cost per bushel of the grain used was $3.61 per bushel. When the same mix was contemplated on Apr. 10, 2001, the cost per bushel was $3.95 resulting in a cost overrun of $338.80 from the previous blend manufacture.

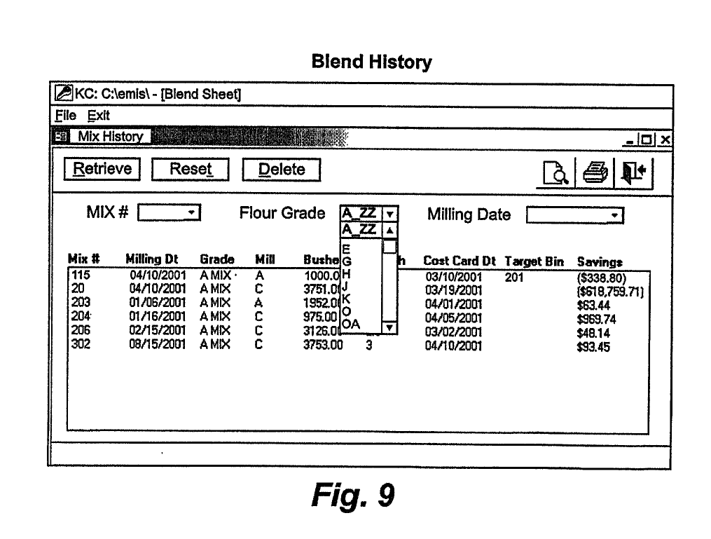

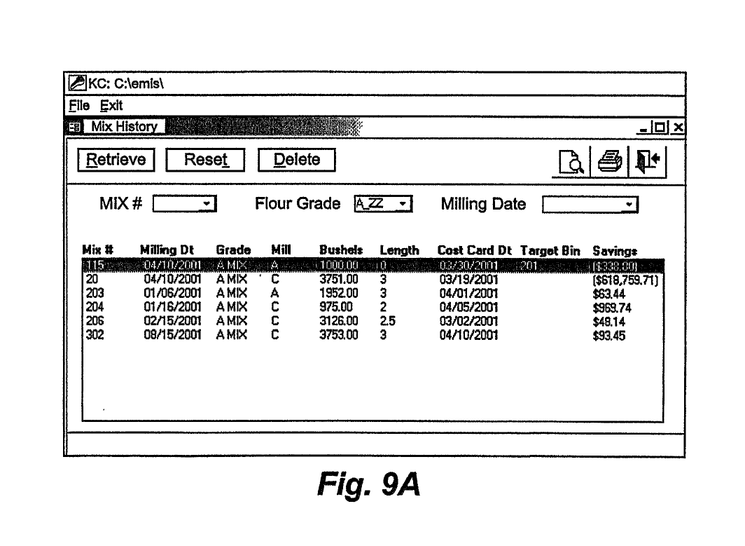

FIGS. 9, 9A and 10 show exemplary illustrative blend history functions and reports. For example, FIG. 9 shows a selection screen that displays a history of different blends that have been used in the past. If the user wishes to view a report of a selected blend, he or she may double click on the blend in this screen or do a search based on, for example, mix number, flour grade, milling data ,or other parameters. FIG. 9A shows an exemplary selection of a particular mix number for purposes of illustration. FIG. 10 shows an example blend history report.

While the preferred embodiments of the present invention relate to grains and the manufacture of flour, it should be understood that this system is applicable to other ingredients and components such as types of sugar, spices or salt or even food intermediates such as flour or dough. The system is applicable to any manufacturing operation where the manufacturer or processor can select from a number of ingredient or component sources.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method for optimizing ingredient selection for further processing comprising the steps of;
providing a supply of at least one ingredient;
calculating at least a first element of said at least one ingredient contained within said supply; and
selecting said at least one ingredient from said supply based on said calculation which correspond to a predetermined recipe to achieve an end product.

2. A method for optimizing ingredient selection as recited in claim 1, wherein said first element is an approximate cost of using said ingredient.

3. A method for optimizing ingredient selection as recited in claim 1, wherein said first element relates to nutritional properties of said ingredient.

4. A method for optimizing ingredient selection as recited in claim 1, wherein said first element relates to functional properties of said ingredient.

5. A method for optimizing ingredient selection as recited in claim 3, wherein the nutritional property is protein content.

6. A method for optimizing ingredient selection as recited in claim 3, wherein the nutritional property is fiber content.

7. A method for optimizing ingredient selection as recited in claim 1, wherein said first element relates to a physical property of said ingredient.

8. A method for optimizing ingredient selection as recited in claim 6, wherein the physical property is moisture content.

9. A method for optimizing ingredient selection as recited in claim 6, wherein the physical property is weight.

10. A method for optimizing ingredient selection as recited in claim 1, wherein said recipe is for flour manufacture.

11. A method for optimizing ingredient selection as recited in claim 1, wherein said ingredient is a grain.

12. A method for producing a blended product comprising:
(a) downloading, over a network, time-sensitive data representing the current cost of at least one material whose price fluctuates based at least in part on market conditions;
(b) using said downloaded current cost information to calculate an actual cost of blending said product;
(c) automatically calculating the difference between said actual blend cost and a model blend cost; and
(d) making a decision to blend said product based at least in part on said calculation.

13. The method as in claim 11 wherein said material comprises grain and said downloaded cost data comprises a grain cost card.

14. A system for controlling grain mixing, said system being coupled over a data network to a source of current grain prices, said system receiving information relating to currently prevailing grain cost, said system including:
a blend processor which, based on desired mix and source bin designations and said currently prevailing grain cost, calculates a blend cost and compares said blend cost with a model cost, said blend processor generating a blend mix output that specifies the amount of each of plural grain lots to mix in order to achieve said desired mix; and
a mass storage device operatively coupled to said blend processor, said mass storage device storing historical data concerning previous blends.

15. The method as in claim 13 wherein said blend processor retrieves currently prevailing grain cost data via said data network at least once a day.

16. The system of claim 13 wherein said blend processor generates a blend entry data form providing interactive user input/output.

17. The system as in claim 13 wherein said blend mix output includes number of bushel information, percent protein information, and grain moisture information.

18. The system as in claim 13 wherein said blend mix output includes information indicating a difference between actual blend cost and model blend cost.

19. The system as in claim 13 wherein said blend processor further produces a blend summary sheet for previous blends.

20. The system of claim 13 wherein said blend processor prints a blend mix sheet and a blend summary sheet.

21. The system of claim 13 wherein said grain comprises wheat and said blend processor specifies a blend of plural wheat lots to provide flour of a desired grade.
